(19) United States
(12) Patent Application Publication
(10) Pub. No.: US 2018/0076691 A1
(43) Pub. Date: Mar. 15, 2018

(54) DEVICE THERMAL MANAGEMENT ASSEMBLY AND METHOD

(71) Applicant: Ford Global Technologies, LLC, Dearborn, MI (US)

(72) Inventor: Andrew G. Cheng, Ann Arbor, MI (US)

(21) Appl. No.: 15/262,640

(22) Filed: Sep. 12, 2016

(51) Int. Cl. H02K 9/00

(52) U.S. Cl. CPC H02K 9/005

(57) ABSTRACT

An exemplary thermal management assembly includes a fluid jacket securable to an installed position adjacent a structural housing of a device, the fluid jacket providing at least a first side and a second side of a fluid passageway perimeter, the first side transverse to the second side. An exemplary method of managing thermal energy in a device includes positioning a fluid jacket in an installed position where the fluid jacket is adjacent a structural housing of an electric device. Without modifying the structural housing, the method includes repositioning the fluid jacket in an uninstalled position where the fluid jacket is spaced from the structural housing.

### TECHNICAL FIELD

This disclosure relates generally to a fluid jacket used to thermally control a device. The device can be an electric device, such as an electric motor.

### BACKGROUND

Devices used in many industries can benefit from thermal control. An example of such a device is an electric device, which could be an electric machine, pump, fan, turbine, or compressor. Other devices, such as internal compression engines, batteries, and energy storage devices, could also benefit from thermal control.

Devices have many uses. Electrified vehicles, for example, can be selectively driven using one or more electric machines powered by a battery pack. The electric machines can drive the electrified vehicles instead of, or in addition to, an internal combustion engine. Example electrified vehicles that may use electric machines include hybrid electric vehicles (HEVs), full-hybrid electric vehicles (FHEVs), plug-in hybrid electric vehicles (PHEVs), fuel cell vehicles (FCVs), and battery electric vehicles (BEVs).

Heating or cooling devices are sometimes required to maintain the device within a desired temperature range. Accordingly, some devices incorporate fluid channels or grooves within structural components, such as an outer structural housing. The fluid channels are cast with the structural components. Fluid is moved through the fluid channels to cool or heat the device. The fluid channels are covered by a plate to hold the fluid within the fluid channels. Since the fluid channels are provided by structural components of the device, removing the fluid channels without disrupting the structural integrity of the device can be difficult.

### SUMMARY

A thermal management assembly according to an exemplary embodiment of the present disclosure includes, among other things, a fluid jacket that is securable to an installed position adjacent a structural housing of a device. The fluid jacket provides at least a first side and a second side of a fluid passageway perimeter. The first side is transverse to the second side.

In a further non-limiting embodiment of the foregoing assembly, the structural housing provides a third side of the fluid passageway perimeter.

In a further non-limiting embodiment of any of the foregoing assemblies, the fluid passageway perimeter is provided entirely by the fluid jacket.

In a further non-limiting embodiment of any of the foregoing assemblies, a fluid passageway having the fluid passageway perimeter is coiled about the device when the fluid jacket is in the installed position.

In a further non-limiting embodiment of any of the foregoing assemblies, the fluid jacket is a polymer material.

In a further non-limiting embodiment of any of the foregoing assemblies, the fluid jacket is a metallic material.

In a further non-limiting embodiment of any of the foregoing assemblies, the fluid jacket includes a first portion and a second portion that meet at an interface such that the fluid jacket circumferentially surrounds the device when the fluid jacket is in the installed position.

A further non-limiting embodiment of any of the foregoing assemblies includes the device as an electric motor having a rotor and a stator within the structural housing. The rotor is configured to rotate about an axis, and the fluid jacket is moved along the axis to position the fluid jacket about the structural housing in the installed position.

In a further non-limiting embodiment of any of the foregoing assemblies, a first section of the fluid passageway having the fluid passageway perimeter is coiled about a radially outermost surface of the structural housing, and a second section of the fluid passageway having the cooling passageway perimeter is positioned adjacent an axially facing end portion of the structural housing when the fluid jacket is in the installed position.

In a further non-limiting embodiment of any of the foregoing assemblies, the fluid jacket is cup-shaped and has an open area to receive the rotor, stator, and structural housing when the fluid jacket is in the installed position.

A method of managing thermal energy according to another exemplary embodiment of the present disclosure includes, among other things, positioning a fluid jacket in an installed position where the fluid jacket is adjacent a structural housing of a device and, without modifying the structural housing, repositioning the fluid jacket in an uninstalled position where the fluid jacket is spaced from the structural housing.

A further non-limiting embodiment of the foregoing method includes moving a fluid through a fluid passageway of the fluid jacket when the fluid jacket is in the installed position. The fluid passageway has a fluid passageway perimeter with at least a first side and a second side provided by the fluid jacket. The first side is transverse to the second side.

In a further non-limiting embodiment of any of the foregoing methods, the fluid passageway perimeter is provided entirely by the fluid jacket.

In a further non-limiting embodiment of any of the foregoing methods, a third side of the fluid passageway perimeter is provided by the structural housing.

In a further non-limiting embodiment of any of the foregoing methods, the fluid passageway follows a coiled path about the device.

In a further non-limiting embodiment of any of the foregoing methods, the device is an electric motor having a rotor and a stator within the structural housing. The rotor is configured to rotate about an axis. The method includes moving the fluid jacket along the axis to position the fluid jacket in the installed position, and moving the fluid jacket along the axis to reposition the fluid jacket in the uninstalled position.

In a further non-limiting embodiment of any of the foregoing methods, when the fluid jacket is in the installed position, a first section of the fluid passageway is coiled about a radially outermost surface of the structural housing, and a second section of the fluid passageway is positioned adjacent an axially facing end portion of the structural housing.

A further non-limiting embodiment of the methods includes molding the fluid jacket from a polymer material.

A further non-limiting embodiment of the methods includes forming the fluid jacket from a metallic material.

A further non-limiting embodiment of the methods includes 3-D printing the fluid jacket.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a highly schematic view of a powertrain for an example electrified vehicle.

FIG. 2 illustrates a perspective view of an example fluid jacket in an uninstalled position relative to an electric device from the powertrain of FIG. 1.

FIG. 3 illustrates the example fluid jacket of FIG. 2 in an installed position about the electric device.

FIG. 4 illustrates a path fluid travels when moving through the fluid jacket of FIG. 3 about the electric device.

FIG. 5 illustrates a cross-section of the fluid jacket at line 5-5 in FIG. 2.

FIG. 6 illustrates a cross-section of the fluid jacket and electric device at line 6-6 in FIG. 3.

FIG. 6A illustrates a cross-section of a fluid jacket according to another exemplary embodiment.

FIG. 7 illustrates a cross-sectional view of the electric device at line 7-7 in FIG. 2.

FIG. 8 illustrates a fluid path associated with a fluid jacket according to another exemplary embodiment.

FIG. 9 illustrates a fluid jacket according to yet another exemplary embodiment in an uninstalled position about the electric device.

FIG. 10 illustrates the fluid jacket of FIG. 9 in an installed position about the electric device.

### DETAILED DESCRIPTION

This disclosure relates to a fluid jacket used to manage thermal energy levels in a device, such as an electric device. The fluid jacket is removably securable to a structural housing of the device. Removably secured, for purposes of this disclosure, means that the fluid jacket can be removed from an installed position relative to the device without disrupting the structural integrity of the device.

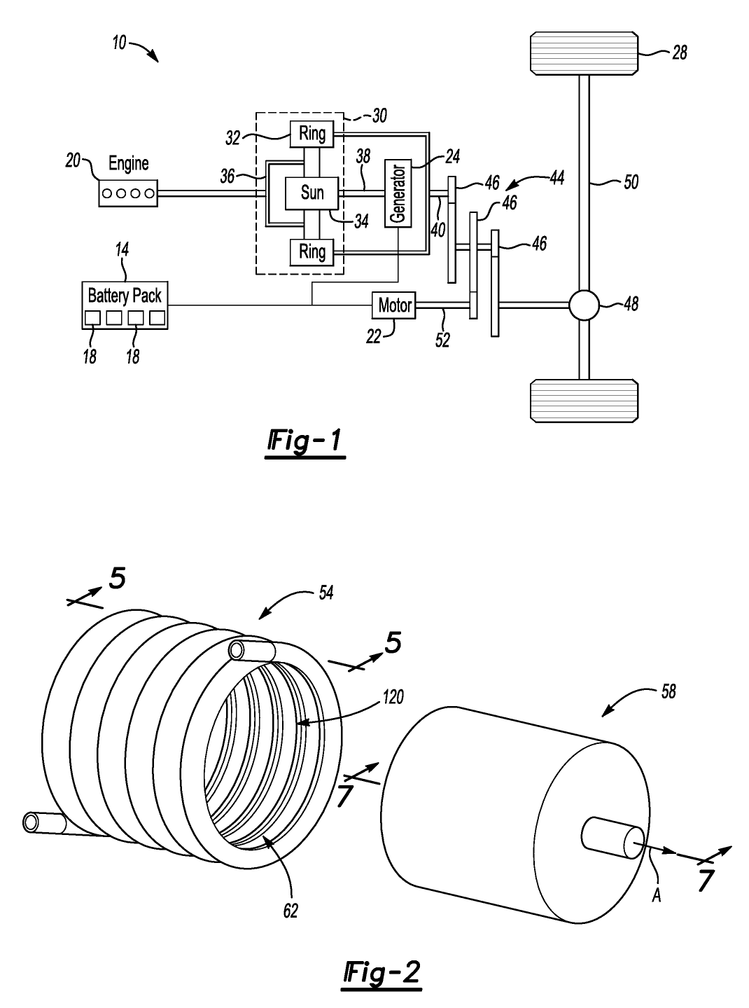

Referring to FIG. 1, a powertrain 10 of a hybrid electric vehicle (HEV) includes a battery pack 14 having a plurality of battery arrays 18, an internal combustion engine 20, a motor 22, and a generator 24. The motor 22 and the generator 24 are types of electric machines. The motor 22 and generator 24 may be separate or have the form of a combined motor-generator.

In this embodiment, the powertrain 10 is a power-split powertrain that employs a first drive system and a second drive system. The first and second drive systems generate torque to drive one or more sets of vehicle drive wheels 28. The first drive system includes a combination of the engine 20 and the generator 24. The second drive system includes at least the motor 22, the generator 24, and the battery pack 14. The motor 22 and the generator 24 are portions of an electric drive system of the powertrain 10.

The engine 20 and the generator 24 can be connected through a power transfer unit 30, such as a planetary gear set. Of course, other types of power transfer units, including other gear sets and transmissions, can be used to connect the engine 20 to the generator 24. In one non-limiting embodiment, the power transfer unit 30 is a planetary gear set that includes a ring gear 32, a sun gear 34, and a carrier assembly 36.

The generator 24 can be driven by the engine 20 through the power transfer unit 30 to convert kinetic energy to electrical energy. The generator 24 can alternatively function as a motor to convert electrical energy into kinetic energy, thereby outputting torque to a shaft 38 connected to the power transfer unit 30.

The ring gear 32 of the power transfer unit 30 is connected to a shaft 40, which is connected to the vehicle drive wheels 28 through a second power transfer unit 44. The second power transfer unit 44 may include a gear set having a plurality of gears 46. Other power transfer units could be used in other examples.

The gears 46 transfer torque from the engine 20 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 can be selectively employed to drive the vehicle drive wheels 28 by outputting torque to a shaft 52 that is also connected to the second power transfer unit 44. In this embodiment, the motor 22 and the generator 24 cooperate as part of a regenerative braking system in which both the motor 22 and the generator 24 can be employed as motors to output torque. For example, the motor 22 and the generator 24 can each output electrical power to recharge cells of the battery pack 14.

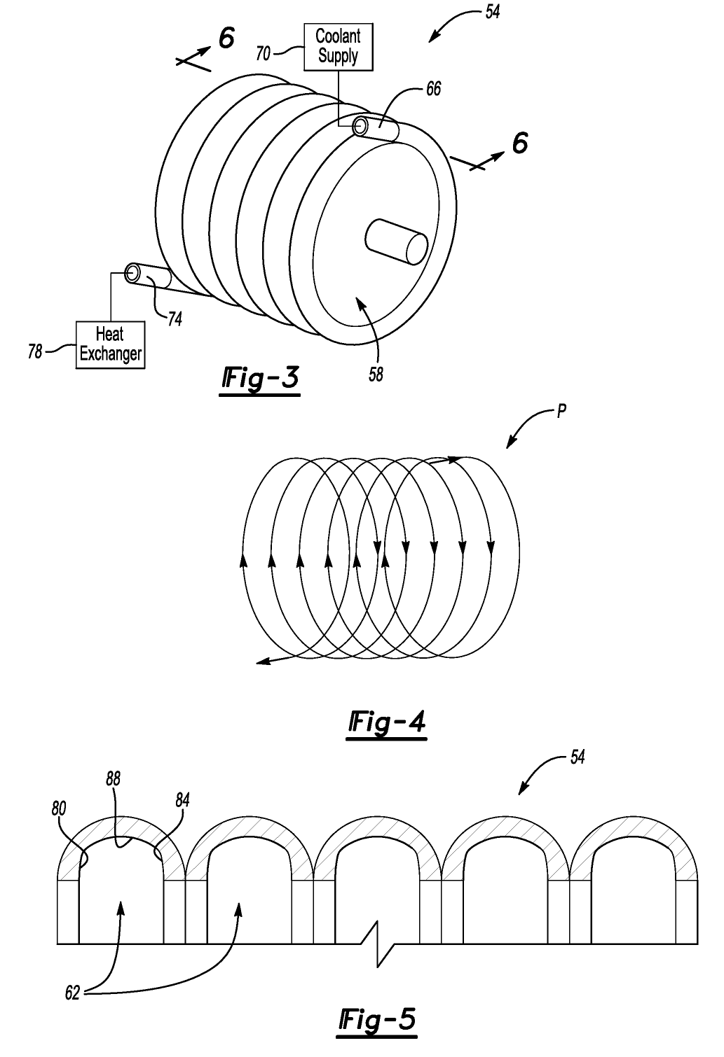

Referring now to FIGS. 2 and 3, a fluid jacket 54 is used to manage thermal energy levels in a device 58. In the example non-limiting embodiment, the device 58 is an electric device. The motor 22 and the generator 24 of the FIG. 1 powertrain 10 are both examples of the device 58.

In another non-limiting embodiment the device 58 could be incorporated into a powertrain of another type of vehicle, such as a conventional vehicle, a full-hybrid electric vehicle (FHEV), a plug-in hybrid electric vehicle (PHEV), a fuel cell vehicle (FCV), or a battery electric vehicle (BEV).

In another non-limiting embodiment, the fluid jacket 54 could be used in connection with a device other than an electric device that would benefit from thermal control.

The fluid jacket 54 provides a plurality of fluid passageways 62. When the fluid jacket 54 is in an installed position of FIG. 3, a fluid, such as a coolant, can be moved through the fluid passageways 62. Thermal energy can be transferred between the device 58 and the fluid.

In this example, thermal energy is transferred from the device 58 to the fluid to cool the device 58. In another example, thermal energy is transferred from the fluid to the device 58 to heat the device 58.

Fluid is communicated to the fluid passageways 62 of the fluid jacket 54 through an inlet port 66. A coolant supply 70, in this example, provides the fluid. Example fluids include refrigerants, oil, water, and air.

Fluid is communicated from the fluid passageways 62 of the fluid jacket 54 through an outlet port 74. In this example, fluid from the outlet port 74 moves to a heat exchanger 78. The fluid is heated when moving through the fluid passageways 62. The heat exchanger 78 is used to transfer thermal energy from the heated fluid.

Fluid from the heat exchanger 78 can then be communicated back to the coolant supply 70, for example.

When moving through the fluid jacket 54 from the inlet port 66 to the outlet port 74, the fluid follows a path P shown in FIG. 4. The path P is coiled about the device 58. The path P is a spiraled path. In another example, the path P is snaked around the device 58. When snaked, the path P extends parallel to the axis A in a first direction, and then turns to extend parallel to the axis A in a second direction opposite the first direction. The path P continues turning between the first and second directions until the path P traverses the around the circumference of the axis A.

The inlet port 66 and the outlet port 74 are integrated into the example fluid jacket 54. The inlet port 66 and outlet port 74 could also be fastened to the fluid jacket 54 after the fluid jacket 54 is formed.

The fluid jacket 54 can, in some examples, include turbulence generators that extend into the fluid passageways 62 to influence the flow of fluid and promote thermal energy transfer. The turbulence generators could include fins, grooves, pins, baffles, or blades, and can be formed together with the fluid jacket 54.

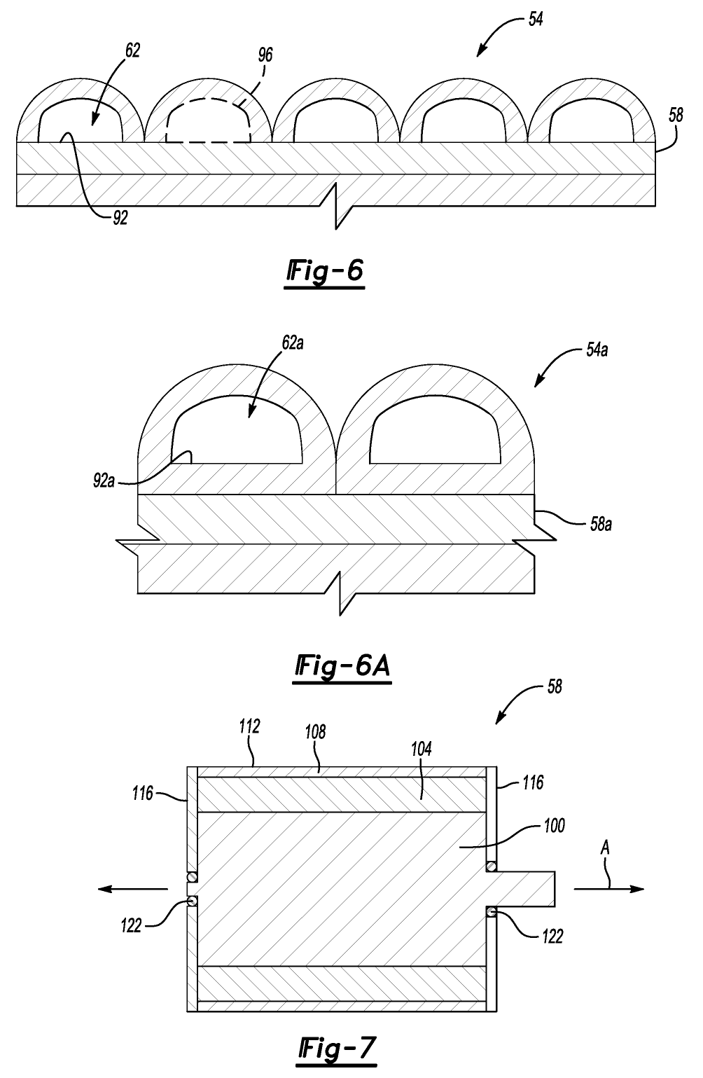

Referring now to FIGS. 5 and 6 with continued reference to FIGS. 2-4, the fluid passageways 62 generally include a first side 80, an opposing second side 84, and a top side 88. In the exemplary embodiment, the first side 80, the second side 84, and the top side 88 are provided by the fluid jacket 54.

As shown in FIG. 6, a radially outermost surface 92 of the device 58 provides a surface that extends from the first side 80 to the second side 84 to complete a fluid passageway perimeter 96 of the fluid passageway 62. The outermost surface 92 is a surface of a structural component of the device 58. In this example, the fluid passageway perimeter 96 is provided by the first side 80, the second side 84, the top side 88, and the surface 92 of the device 58.

The first side 80, the second side 84, the top side 88 are oriented transversely to each other. Fluid moving through the fluid passageways 62 is held within the fluid passageway perimeter 96. Seals, gaskets, or sealants could be used to contain the fluid within the fluid passageway perimeter 96 of the fluid passageway 62.

In this exemplary embodiment, the surface 92 is substantially flat and includes no formations, such as grooves or ridges, corresponding to the fluid passageways 62. The non-smooth portions of the fluid passageway perimeter 96 are provided entirely by the fluid jacket 54. Machining or casting the outermost surface 92 to provide the fluid passageways 62, or a portion of the fluid passageways 62, is thus not required.

In another example, the surface 92 includes grooves or ridges to provide some portion of the fluid passageways 62.

Referring now to FIG. 6A, a fluid jacket 54a according to another exemplary embodiment provides an entire perimeter of fluid passageways 62a that extend about a device 58a. Since the fluid jacket 54a provides the entire perimeter, a surface 92a of the device 58a is not required to complete a perimeter of the fluid passageways 62a.

Referring now to FIG. 7, the example device 58 is an electric device that includes a rotor 100 received within a stator 104. A structural housing 108 houses the rotor 100 and the stator 104. The housing 108 includes radially facing sides 112 and axially facing sides 116.

If the device 58 is used as the motor 22 of the powertrain 10 in FIG. 1, rotating the rotor 100 about an axis A provides torque. If the device 58 is used as the generator of the powertrain 10 in FIG. 1, rotating the rotor 100 about the axis A can generate electric power. The rotor 100 could rotate in response to a torque input from regenerative braking, for example.

The housing 108 structurally supports both the stator 104 and the rotor 100. The housing 108 could include support structures for bearings 122 that rotatably support the rotor 100. The housing 108 is considered a structural support as the housing 108 accommodates the stresses associated with counteracting the device 58 during operation. That is, the housing 108 resists the counter-torque associated with rotation of the rotor 100. Another structural function of the exemplary housing 108 is supporting the bearing 122 and counteracting forces that can move the rotor 100 with respect to the stator 104. In this example, the fluid jacket 54 provides substantially no resistance to counteract the torque associated with rotation of the rotor 100, nor does it provide counteracting forces to support the rotor 100 with respect to the stator 104. The fluid jacket 54 is thus not considered to be a structural support.

In some examples, the stator 104 is press fit within the radially facing sides 112 of the housing 108. The axially facing sides 116 are then secured directly to the radially facing sides 112 to secure the stator 104 along the axis A within the housing 108.

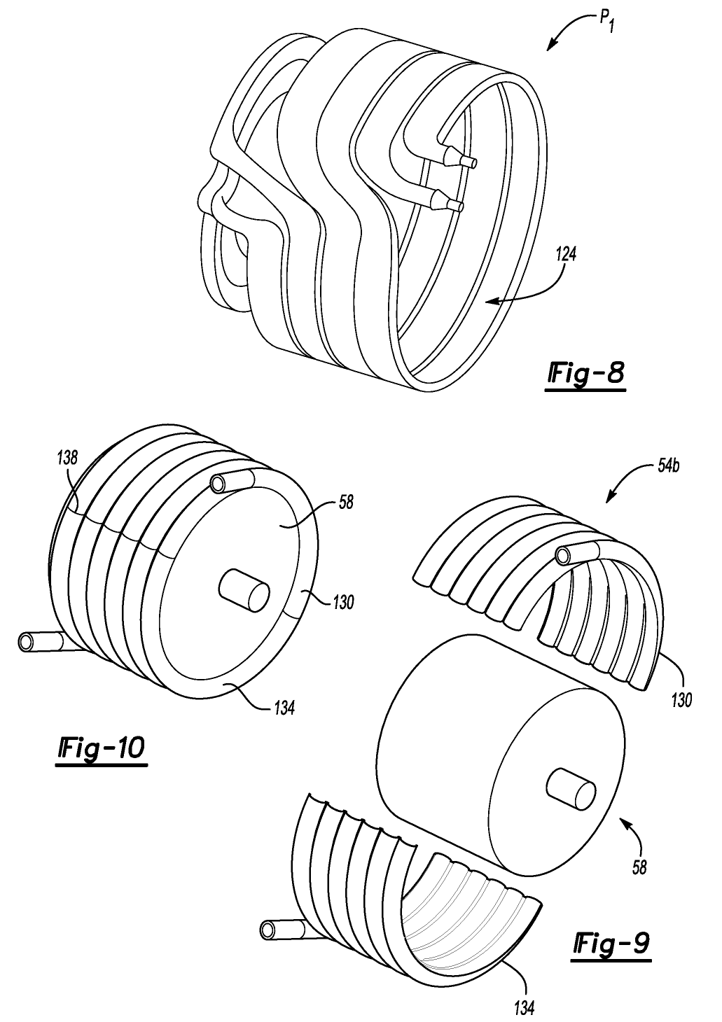

The fluid jacket 54 extends about the radially facing sides 112 of the housing 108. As shown in FIG. 8, another example fluid jacket could provide a fluid flow path P₁ that extends about both the radially facing sides 112 and one or more of the axially facing sides 116 of the housing 108. The fluid flow path P₁ include a first section adjacent the radially facing sides and a second section adjacent one of the axially facing sides 116. The first section is coiled. The second section can be used to cool bearings or internal areas of a device. The fluid jacket providing the path P₁ in FIG. 8 has a cup-shaped profile providing an opening 124 to receive an electric device such as the device 58 of FIG. 2.

Referring again to FIG. 2, the device 58 can be moved relative to the fluid jacket 54 along the axis A to position the device 58 within an open area 120 of the fluid jacket 54 in the installed position of FIG. 3. The device 58 can then be moved relative to the fluid jacket 54 along the axis A to reposition the fluid jacket 54 in the uninstalled position of FIG. 2.

Screws or other types of mechanical fasteners can be used to hold the fluid jacket 54 in the installed position. Clamps could instead, or additionally, be used, as well as bolts, adhesives, and welds.

The example fluid jacket 54 is not a structural component of the device 58. Thus, moving the fluid jacket 54 back and forth between the uninstalled position and the installed position does not substantially disrupt the structural integrity of the device 58. When the fluid jacket 54 is removed from the device 58, no grooves or ridges remain in the device 58. Since the fluid passageways 62 are entirely contained within the fluid jacket 54, the fluid jacket 54 is well-suited to aftermarket applications where thermal management is desired, but machining grooves in a housing is not.

The example fluid jacket 54 is a polymer material. To manufacture the fluid jacket 54, a liquid polymer can be injected into a mold containing a cavity corresponding dimensionally to the desired dimensions for the fluid jacket 54. The liquid polymer cures within the mold to provide the fluid jacket 54. Since the fluid jacket 54 is a polymer, the fluid jacket 54 is relatively lightweight.

After removing the fluid jacket 54 from the mold, the fluid jacket 54 is slid over the device 58 to the installed position. Alternatively, the fluid jacket 54 could be molded about the device 58.

The fluid jacket 54, when made of the polymer material, could also be extruded, stamped, blow molded, or 3D printed.

Another example method for manufacturing the fluid jacket 54 could include 3-D printing the fluid jacket 54. When 3-D printed, the fluid jacket 54 could be a metallic material, a polymer material, or some combination of metallic and polymer materials. Exemplary 3-D printing techniques include, but are not limited to, stereolithography (SLA), digital light processing (DLP), fused deposition modeling (FDM), selective laser sintering (SLS), selective laser melding (SLM), electronic beam melting (EBM), and laminated object manufacturing (LOM).

In another example, the fluid jacket 54 could be made of a metallic material. A casting process may be used to provide the fluid jacket made of a metallic material. The fluid jacket made of the metallic material could also be stamped or 3D printed.

Referring now to FIGS. 9 and 10, a fluid jacket 54b according to another exemplary embodiment of the present disclosure has a two-piece design. The fluid jacket 54b includes a first portion 130 and a second portion 134 that is separate from the first portion 130. When in the installed position about the device 58, the first portion 130 and the second portion 134 meet at an interface 138 to circumferentially surround the electric device. The fluid passageways 62b extend between the first portion 130 and the second portion 134. The fluid jacket 54b could be a polymer material, a metallic material, or some combination of these. Other exemplary embodiments could include multiple pieces and total more than two pieces.

Features of some of the disclosed examples include a fluid jacket that can be moved to an installed position and moved to an uninstalled position relative to an electric device without requiring complicated fastening systems, and without disrupting the structural integrity of the electric device. Because the fluid jacket can be separated from the electric device, the fluid jacket can be made of a different material than the electric device, and weight savings can be realized.

Some of the disclosed examples provide a fluid jacket made of a polymer material to, among other things, provide significant weight savings over known fluid jackets. Specific polymers can be selected to optimize for cost, weight, designs, engineering specifications, etc.

Some of the disclosed examples provide a fluid jacket that is relatively lightweight, modular, efficient, and cost-effective. The fluid jacket could be stamped of a metallic material that is lighter than a housing of the electric device. Stamping the fluid jacket can reduce manufacturing time.

Since the fluid jacket is separate from the electric device, functional prototypes and production parts could be made with 3D printing techniques. Further, structural stiffeners can be designed into the electric device separate from fluid flow enhancers designed into the fluid jacket.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A thermal management assembly, comprising:
a fluid jacket securable to an installed position adjacent a structural housing of a device, the fluid jacket providing at least a first side and a second side of a fluid passageway perimeter, the first side transverse to the second side.

2. The thermal management assembly of claim 1, wherein the structural housing provides a third side of the fluid passageway perimeter.

3. The thermal management assembly of claim 1, wherein the fluid passageway perimeter is provided entirely by the fluid jacket.

4. The thermal management assembly of claim 1, wherein a fluid passageway having the fluid passageway perimeter is coiled about the device when the fluid jacket is in the installed position.

5. The thermal management assembly of claim 1, wherein the fluid jacket is a polymer material.

6. The thermal management device of claim 1, wherein the fluid jacket is a metallic material.

7. The thermal management assembly of claim 1, wherein the fluid jacket includes a first portion and a second portion that meet at an interface such that the fluid jacket circumferentially surrounds the device when the fluid jacket is in the installed position.

8. The thermal management assembly of claim 1, further comprising the device as an electric motor having a rotor and a stator within the structural housing, wherein the rotor is configured to rotate about an axis, and the fluid jacket is moved along the axis to position the fluid jacket about the structural housing in the installed position.

9. The thermal management assembly of claim 8, wherein a first section of the fluid passageway having the fluid passageway perimeter is coiled about a radially outermost surface of the structural housing, and a second section of the fluid passageway having the cooling passageway perimeter is positioned adjacent an axially facing end portion of the structural housing when the fluid jacket is in the installed position.

10. The thermal management assembly of claim 9, wherein the fluid jacket is a cup-shaped and has an open area to receive the rotor, stator, and structural housing when the fluid jacket is in the installed position.

11. A method of managing thermal energy in an electric device, comprising:
positioning a fluid jacket in an installed position where the fluid jacket is adjacent a structural housing of a device; and
without modifying the structural housing, repositioning the fluid jacket in an uninstalled position where the fluid jacket is spaced from the structural housing.

12. The method of claim 11, further comprising moving a fluid through a fluid passageway of the fluid jacket when the fluid jacket is in the installed position, the fluid passageway having a fluid passageway perimeter with at least a first side and a second side provided by the fluid jacket, the first side transverse to the second side.

13. The method of claim 12, wherein the fluid passageway perimeter is provided entirely by the fluid jacket.

14. The method of claim 12, wherein a third side of the fluid passageway perimeter is provided by the structural housing.

15. The method of claim 12, wherein the fluid passageway follows a coiled path about the device.

16. The method of claim 12, wherein the device is an electric motor having a rotor and a stator within the structural housing, wherein the rotor is configured to rotate about an axis, and further comprising moving the fluid jacket along the axis to position the fluid jacket in the installed position, and moving the fluid jacket along the axis to reposition the fluid jacket in the uninstalled position.

17. The method of claim 16, wherein, when the fluid jacket is in the installed position, a first section of the fluid passageway is coiled about a radially outermost surface of the structural housing, and a second section of the fluid passageway is positioned adjacent an axially facing end portion of the structural housing.

18. The method of claim 11, further comprising molding the fluid jacket from a polymer material.

19. The method of claim 11, further comprising forming the fluid jacket from a metallic material.

20. The method of claim 11, further comprising 3-D printing the fluid jacket.
